(19) United States
(12) Patent Application Publication
(10) Pub. No.: US 2024/0314503 A1
(43) Pub. Date: Sep. 19, 2024

(54) HEARING AID AND METHOD FOR ESTIMATING A SOUND PRESSURE LEVEL

(71) Applicant: Oticon A/S, Smørum (DK)

(72) Inventors: Adel ZAHEDI, Smørum (DK); Rémi DECORSIÈRE, Smørum (DK); Thomas G. HANSEN, Smørum (DK); Silje NIELSEN, Smørum (DK); Eric BOYER, Smørum (DK)

(21) Appl. No.: 18/592,542

(22) Filed: Mar. 1, 2024

(30) Foreign Application Priority Data
Mar. 15, 2023 (EP) 23161968.5

(51) Int. Cl. H04R 25/00

(52) U.S. Cl. CPC H04R 25/505; H04R 25/554; H04R 25/70

(57) ABSTRACT

Disclosed herein are embodiments of a method performed by a hearing aid and a hearing aid. An acoustical model can be used to generate first values (hₖ) for the multiple frequency channels based on first parameters (G, A, l); and a statistical model can be configured to generate second values (rₖ) for the multiple frequency channels based on values of second parameters (s₁, s₂, . . . , sₙ) and a set of basis vectors (u₁, u₂, . . . , uₙ). An optimizer can be configured to obtain an optimized set of parameter values, wherein the optimized set of parameter values can be obtained by minimizing a difference between the first sound pressure levels (r_{obs}) and a combination of the first values (rₖ) and the second values (hₖ).

The present disclosure relates to a method at a hearing aid for estimating a sound pressure level at a wearer's eardrum based on a measurement at a distance from the eardrum. The present disclosure also relates to a corresponding hearing aid.

### BACKGROUND

In hearing care, it is generally desired to know what sounds pressure levels a hearing aid generates at the real eardrum of the wearer, rather than in a measurement device. One measurement device is known as a so-called coupler, e.g., a 2 cc coupler (2 cubic centimetres), which is configured to receive the hearing aid at one end of a duct and includes a microphone at the other end of the duct. Such a coupler is often used for performing standardized measurements in the hearing care industry. However, a coupler is less useful for measuring the sound pressure level at the eardrum of a specific person. Thus, despite their inconvenience, e.g., due to insertion of a specialized measurement device e.g., including a so-called probe tube, very close to the eardrum, measurements of sound pressure levels at the eardrum are commonly used by hearing care professionals.

At least in some areas of hearing care, there is establish a technical term, sometimes denoted real-ear-to-coupler difference often abbreviated RECD. This term relates to a (frequency-specific) difference in sound pressure level between what is measured in a coupler and what is measured in a real ear. There exists databases including RECD measurement for a vast amount of persons.

Generally, hearing aids have one or more microphones arranged to capture sounds from the surroundings of a wearer of the hearing aid and to output corresponding electrical signals. The one or more microphones are sometimes denoted ambient microphones. The ambient microphones may include a so-called front-microphone sitting closer to the face of the wearer than a so-called rear-microphone. The electrical signals are processed a processor performing hearing loss compensation including prescribed frequency-specific gain correction and compression in accordance with a determined hearing loss. The processor generates an output signal, including hearing loss compensation, for an output transducer emitting an acoustical signal towards the user's eardrum. An advantage of using more than one ambient microphone is that the processor can be configured to perform spatial filtering sometimes denoted beamforming.

More recently, some hearing aids include an integrated microphone arranged to capture sounds inside the wearer's ear-canal. Such a microphone is sometimes denoted an inward-facing microphone, an in-ear microphone or an ear-canal microphone. However, such an inward-facing, in-ear or ear-canal microphone sits at a distance from the eardrum e.g., at a distance of 10-25 millimetres. At least therefore an in-ear microphone generates a poor measurement of the sound pressure level at the eardrum.

Obtaining an accurate measure of the sound pressure levels that are delivered to the eardrum of a given wearer of the hearing aid is of manifold interest in hearing care, e.g., for output calibration, insertion gain evaluation and performance analysis.

For practical reasons such as user comfort, required equipment, etc., it is best to avoid direct measurements of the levels at the eardrum and replace such procedures with indirect methods. One viable indirect alternative is to measure the levels at the entrance to the ear canal, and then estimate the eardrum levels from the measurement. This shifts the challenge from physically reaching the eardrum to dealing with the problem of designing a reliable estimation technique.

### SUMMARY

There is provided:

A method performed using a hearing aid including a processor, a first microphone, and an output transducer; wherein the first microphone is arranged to capture sounds inside a wearer's ear-canal at a distance from the eardrum; comprising:
emitting a first output signal using the output transducer;
receiving a first input signal using the first microphone, and determining first sound pressure levels (r_{obs}) at multiple frequency channels;

wherein an acoustical model is configured to generate first values (hₖ) including values for each of the multiple frequency channels based on first parameters (G, A, l);

wherein a statistical model is configured to generate second values (rₖ) including values for each of the multiple frequency channels based on second parameters (s₁, s₂, . . . , sₙ) and a set of basis vectors (u₁, u₂, . . . , uₖ);
determining a set of optimized parameter values ({G, A, l, s₁, s₂, . . . , sₙ}*) including values of the first parameters and values of the second parameters; wherein a difference between the first sound pressure levels (r_{obs}) and a combination of the first values (hₖ) and the second values (rₖ) is minimized via the acoustical model and the statistical model; and
generating the second values (r*ₖ) for the multiple frequency channels using the statistical model and at least the second parameter values ({s₁, s₂, . . . , sₙ)}*) included in the optimized set of parameter values.

An advantage is that sound pressure levels at the eardrum of the wearer of hearing aid can be accurately determined using a hearing aid with a microphone arranged to capture ear-canal sounds only at a distance from the ear drum.

An advantage is that the acoustical model and the statistical model can be jointly estimated to obtain the set of optimized parameter values. Subsequently, the statistical model can be used with the second parameter values included in the set of optimized parameter values to estimate the sound pressure level at the eardrum. Thus, the sound pressure level at the eardrum becomes readily available by the statistical model.

An advantage is that the models in combination enable representing different variations of the first sound pressure levels, while enabling a compact representation in a memory.

In some respects, the second values are included in performing one or more of:
calibration of an output signal to the output transducer to obtain a desired sound pressure level at the eardrum of the specific wearer of the hearing aid; and
insertion gain evaluation or performance analysis, e.g., during a fitting session, where the sound pressure level at the eardrum of the specific wearer is displayed on a display of an electronic device, e.g., a personal computer.

In some respects, the acoustical model includes a representation of a closed-form expression.

In some respects, the set of vectors is a set of basis vectors or includes a set of basis vectors. In some respects, the set of vectors are substantially orthogonal and/or approximately forms a set of basis vectors.

In some examples, the number of basis vectors is less than six, e.g., five, four, three or two. In some examples, the number of second parameters is equal to the number of basis vectors.

In some respects, the set of optimized parameter values is obtained based on an objective function including the first sound pressure levels (r_{obs}), the first values (hₖ) and the second values (rₖ) and an algorithm for solving an optimization problem including the objective function. An example of an algorithm for solving an optimization problem is the well-known least squares approximation algorithm.

In some respects, the level estimator is configured to generate an envelope of a signal input to the estimator. Generating the envelope may include lowpass filtering an absolute value of the input signal. In some examples, the lowpass filtering includes different ‘attack/release’ times.

In some respects, the hearing aid includes a filter bank dividing the input signal into multiple frequency channels. In some examples, a level estimator is included for each frequency channel.

In some respects, the hearing aid includes a second microphone; wherein the second microphone is arranged to capture sounds from surroundings of the wearer. The second microphone is thus a well-known component of a conventional hearing aid. In the conventional hearing aid, a forward signal path is formed between the second microphone and an output transducer. The forward signal path may include a compensator to compensate for a prescribed hearing loss.

In some respects, the hearing aid includes a filter bank configured to divide the first signal into the multiple frequency channels and/or the divide the second signal into the multiple frequency channels.

In some embodiments the first parameters include values that are frequency-channel-independent; and/or wherein the second parameters include values that are frequency-channel-independent.

An advantage is the robust estimation even for a smaller number, e.g., less than 5, frequency channels. Typically, a hearing aid includes at least 8 frequency channels e.g., 16, 32 or 64 frequency channels or fewer or more frequency channels.

Since the parameters are frequency channel independent, the first parameters and/or the second parameters have each a value which is common for all frequency channels or at least common for a subset of the frequency channels.

In some embodiments the second parameter values ({s₁, s₂, . . . , sₙ}*) included in the optimized set of parameter values and the vectors together model a specific set of real-ear-to-coupler differences, wherein the real-ear-to-coupler difference set includes a value for each frequency channel. An advantage is that the second values correspond with measurable real-ear-to-coupler differences.

In some embodiments the acoustical model and the statistical model generate linearly independent first values (hₖ) and second values (rₖ).

An advantage is that the acoustical model can model the transmission of sound between the eardrum and the hearing aid, whereas, independently therefrom, the statistical model can model the sound pressure level at the eardrum. This means that the first parameters and the second parameters can be jointly estimated and subsequently the second model can be used, without the first model, to generate an accurate estimate of the sound pressure level at the eardrum.

A set of vectors are linearly independent if there exists no nontrivial linear combination of the vectors that equals the zero vector. If such a linear combination exists, then the vectors are said to be linearly dependent.

In some respects, the acoustical model and the statistical model mutually and/or together form a substantially orthogonal set of functions. An advantage is that each of the acoustical model and the statistical model become independent, whereby parameters of one or both of the acoustical model and the statistical model can be jointly estimated and subsequently used with the respective one or both models for applying e.g., compensation, independently of one another. The substantially orthogonal set of functions may also be denoted a basis.

In some embodiments the acoustical model, and the statistical model mutually and/or in combination form a substantially orthogonal set of functions; wherein functions associated with the statistical model span at least two, three or four standard deviations of real-ear-to-coupler-difference data associated with at least 20 normal real ear canals.

An advantage is that the sound pressure at the eardrum of most people can be accurately estimated using the hearing aid and only a limited amount of memory space for storing the statistical model. This is not only generally useful but is especially useful in embodiments wherein at least the statistical model is stored in memory included in the hearing aid.

In some respects, the number of the first values and/or the number of the second values is greater than the number of first parameters and second parameters. An advantage is that determination of the optimized parameter values provides a reasonable generalization and optimized parameter values that are robust and stable. An advantage is that the set of optimized parameter values can be determined for a well-posed optimization problem rather than an ill-posed optimization problem. It can be said that the models are included in an overdetermined system.

In some examples, the total count of the first values and/or a total count of the second values is 32 or 64, whereas the number of first parameters is 3 and the number of the second parameters is less than 7 e.g., 5 or 4 or 3.

In some respects, the second values are highly correlated. The second values may have a normalized auto-correlation coefficient above 0.7 or above 0.8 or above 0.9, up to but not including 1.0. The auto-correlation coefficient is preferably above 0.7 at least for all lags up to about half of the number of second values. Thus, the basis vectors each have values that are highly correlated e.g., having a normalized auto-correlation coefficient above 0.7 or above 0.8 or above 0.9, up to but not including 1.0. Comparatively, a difference values between the first sound pressure levels (r_{obs}) and a sum of the first values (rₖ) and the second values (hₖ), obtained at the optimized set of parameter values, is only weakly correlated e.g., at a correlation coefficient below 0.1.

For the sake of completeness, the first values are also highly correlated e.g., with a normalized auto-correlation coefficient above 0.7, 0.8 or 0.9.

In some respects, the basis vectors (u₁, u₂, . . . , uₙ) are linearly independent. An advantage is that only a limited amount of memory space is required for storing the statistical model. This is not only generally useful but is especially useful in embodiments wherein at least the statistical model is stored in memory included in the hearing aid. An advantage is that the sound pressure at the eardrum of most people can be accurately estimated using the hearing aid and only a limited amount of memory space for storing the statistical model. This is not only generally useful but is especially useful in embodiments wherein at least the statistical model is stored in memory included in the hearing aid.

In some embodiments the vectors include basis vectors; and wherein each basis vector includes a value for each of the multiple frequency channels; and wherein the set of basis vectors (U) includes a vector (u₁, u₂, . . . , uₙ) for each of second parameters (s₁, s₂, . . . , sₙ). An advantage is that the statistical model can be implemented by matrix manipulations, which can be efficiently embodied in a processor e.g., included in a hearing aid.

In some embodiments the vectors are obtained based on an eigenvalue decomposition, including eigenvectors (U), of the covariance matrix (Cᵣ) associated with a multitude of real-ear-to-coupler-differences; wherein the second values (r) are a function of the second parameter values (s₁, s₂, . . . , sₙ). An advantage is that the statistical model can be based on generally available real-ear-to-coupler measurements for a population of hearing aid users. The eigenvalue decomposition may be obtained using a Principal Component Analysis, PCA, method, an Independent Component Analysis, ICA, or another method.

In some embodiments the acoustical model includes an expression associated a gain transfer function from one end of a duct to another end of the duct; and wherein the statistical model is configured to enable representation of a real-ear-to-coupler difference based on the basis vectors. By “duct”, it is meant the portion of the ear canal spanning from the eardrum to a part of the hearing aid, e.g. from the eardrum to the inward-facing microphone of the hearing aid.

An advantage is that the acoustical model and the statistical model can be jointly estimated while enabling that the models are independent. The statistical model can then be used separately from the acoustical model (or vice versa). Thus, the sound pressure level at the eardrum becomes readily available by the statistical model. In some examples, the acoustical model includes an expression associated a gain transfer function from one end of a circular duct to another end of the circular duct.

In some embodiments the acoustical model includes an expression including a term associated with a forward propagating sinusoidal wave and a term associated with a backward propagating sinusoidal wave.

An advantage is that the acoustical model can be represented by a relatively simple expression including two terms. An advantage is that a sufficiently accurate function representing propagation of sound through an ear-canal at multiple frequency bands e.g., 16, 32, 64 or another number of frequency bands can be obtained based on as little as e.g., three parameters.

An advantage of the acoustical model is that is enables modelling of the so-called quarter-wave dip associated with standing waves in the ear canal. The quarter-wave dip may suppress the sound level by more than 10 dB e.g., by 20 dB at one or more frequency channels. The backward propagating sinusoidal wave is reflected wave; reflected at the eardrum.

The representation may include a first exponential term and a second exponential term, wherein each exponential term has a scaling coefficient and an exponent, and wherein the exponent of the first exponential term is a negative value.

The expression may represent a transfer function including at least a magnitude transfer function associated with sound propagation through an air duct.

In some embodiments the magnitude transfer function at frequency channel k (1≤k≤K) is given by:

$${h}_{k} = A log \{ {\vert {V}_{k}^{+} {e}^{- j {γ}_{k} l} + {V}_{k}^{-} {e}^{j {γ}_{k} l} \vert}^{2} \}$$

Wherein l is associated with the length of the ear canal, Vₖ⁺=Vₖ⁻=0.5; γₖ²=(R+j2πfₖL) (G+j2πfₖC); R=0; L=C=(speed of sound in air)⁻¹.

In some examples, the optimizer includes constrains on at least some of the parameter values in determining the optimized set of parameter values ({G, A, l, s₁, s₂, . . . , sₙ}*). An advantage it that the at least some parameter values can be constrained to parameter values associated with realistic values of real-ear-to-coupler-differences (RECD). In some examples, the constraints are set based on one or both of physical considerations and statistical considerations.

In some embodiments the hearing aid includes a second microphone arranged to capture sounds from surroundings of a wearer of the hearing aid, comprising;
based on processing a signal from the second microphone, generating an output signal for the output transducer; wherein the processing includes compensation for a prescribed hearing loss;

wherein the processing includes the second values (r*ₖ) to compensate a signal from the second microphone.

An advantage is that the hearing aid is enabled to deliver a desired sound pressure at the eardrum of the wearer; wherein the sound pressure at the eardrum is accurately calibrated.

In some embodiments the method is performed using a system including the hearing aid and an electronic device different from a hearing aid, comprising at the electronic device:
obtaining a multitude of real-ear-to-coupler-differences ([r₁, r₂, . . . , r_{I}]^{T}□);
computing a mean value vector (μᵣ) for the or the multitude of real-ear-to-coupler-differences;
computing a covariance matrix (Cᵣ) for the multitude of real-ear-to-coupler-differences;
computing an eigenvector decomposition (U) of the covariance matrix (Cᵣ);

wherein the eigenvector decomposition (U) includes the basis vectors.

An advantage is that processing associated with computing the basis vectors based on the multitude of real-ear-to-coupler-differences can be performed by an electronic device, e.g., a computer at a production facility or a hearing care professional. At least at the hearing aid, the method is highly efficient in terms of memory usage and power consumption e.g., since only the basis vectors rather than the full set of real-ear-to-coupler-differences must be stored in the memory at the hearing aid.

In some respects, the multitude of real-ear-to-coupler-differences is obtained from a database of real-ear-to-coupler-differences. In some respects, the above steps are performed by an electronic device, e.g., a personal computer.

In some respects, the method includes computing the second values (rₖ) for the multiple frequency channels based on the mean value vector (μᵣ), the basis vectors, and the second parameter values ({s₁, s₂, . . . , sₙ}*).

In some embodiments the method comprises:
at an electronic device, transmitting the basis vectors and the mean value vector (μᵣ) to the hearing aid.

An advantage is that the hearing aid can receive the basis vectors and the mean value vector from an electronic device, rather than computing the basis vectors and the mean value vector at the hearing aid. This saves battery power and processing resources at the hearing aid.

In some embodiments the method is performed by a system including an electronic device with a display and a first radio; and wherein the hearing aid includes a second radio; comprising;
displaying a representation of the second values (r*ₖ) obtained for the multiple frequency channels using the second model and at least the second parameter values ({s₁, s₂, . . . , sₙ}*) included in the optimized set of parameter values;

wherein the electronic device and the hearing aid communicates, via the first radio and via the second radio, at least the first sound pressure levels (r_{obs}).

An advantage is that a fitting can be verified or at least monitored and presented to a wearer and/or hearing care professional.

In some respects, the method additionally or alternatively includes displaying a representation of an aggregation, e.g., a sum, of a target sound pressure level and the second values (r*ₖ) obtained for the multiple frequency channels using the second model and at least the second parameter values ({s₁, s₂, . . . , sₙ)}*) included in the optimized set of parameter values.

In some embodiments the hearing aid includes a second microphone arranged to capture sounds from surroundings of a wearer of the hearing aid; comprising:
receiving a second input signal using the second microphone, and determining second sound pressure levels at multiple frequency channels;
generating the output signal based on at least a signal from the second microphone; and
determining frequency channels at which one or both of the first sound pressure levels and the second sound pressure levels satisfy a first criterion, and enabling determining a set of optimized parameter values ({G, A, l, s₁, s₂, . . . , sₙ}*) only in accordance with a determination that the first criterion is satisfied for one or more, e.g., all, frequency channels.

An advantage is that a sound signal from the surroundings of the wearer is used for generating the set of optimized parameter values however only when the first criterion is satisfied. This improves robustness of the optimized parameter values. In some respects, the first criterion includes a threshold sound pressure level. In some respects, the first criterion includes a first threshold sound pressure level for the first sound pressure levels and a second threshold sound pressure level for the second sound pressure levels. The criterion may be based on a logic assessment of whether the thresholds are exceeded.

In some respects, the method is performed at least in part by the hearing aid.

An advantage is that the hearing aid can generate the compensation values e.g., independently, or recurringly, during normal use of the hearing aid.

In some embodiments the hearing aid includes an antenna for wireless communication with an electronic device; and wherein the method is performed at least in part by the electronic device including a display, a processor and an antenna; comprising:
storing a representation of one or both of the acoustical model and the statistical model in the memory included in the electronic device;
performing determining the optimized set of parameter values ({G, A, l, s₁, s₂, . . . , sₙ}*) at the electronic device;
generating the second values (rₖ) at the electronic device; and
transmitting the second values (rₖ) to the hearing aid.

An advantage is that power consumption at the hearing aid can be reduced, while utilizing processing power of the electronic device. The electronic device may be a personal computer, a mobile electronic device and/or a wearable electronic device e.g., a smartphone, a smartwatch, or a tablet computer, or another type of electronic device.

There is also provided a hearing aid including a processor; comprising:
a first microphone arranged to capture sounds in an ear canal and generate a first signal;
a level estimator determining first sound pressure levels (r_{obs}) at multiple frequency channels;
an acoustical model configured to generate first values (hₖ) for the multiple frequency channels based on first parameters (G, A, l);
a statistical model configured to generate second values (rₖ) for the multiple frequency channels based on values of second parameters (s₁, s₂, . . . , sₙ) and a set of vectors (u₁, u₂, . . . , uₙ) including values;
an optimizer configured to obtain an optimized set of parameter values ({G, A, l, s₁, s₂, . . . , sₙ)}*) including values of the first parameters and values of the second parameters; wherein the optimized set of parameter values is obtained by minimizing a difference between the first sound pressure levels (r_{obs}) and a combination of the first values (rₖ) and the second values (hₖ); and
a generator configured to generate the second values (r*ₖ) for the multiple frequency channels based on the statistical model and at least the second parameter values ({s₁, s₂, . . . , sₙ}*) included in the optimized set of parameter values.

An advantage is that sound pressure levels at the eardrum of the wearer of hearing aid can be accurately determined using a hearing aid with a microphone arranged to capture ear-canal sounds only at a distance from the ear drum.

### BRIEF DESCRIPTION OF THE FIGURES

A more detailed description follows below with reference to the drawing, in which:

FIG. 1 shows a pair of hearing aids in a hearing aid system;

FIG. 2 shows a block diagram of a hearing aid;

FIG. 3 shows a hearing aid sitting in a coupler;

FIG. 4 shows a hearing aid sitting in a real ear;

FIG. 5 shows a block diagram of a hearing aid including an acoustical model and a statistical model;

FIG. 6 shows a block diagram of a hearing aid and an electronic device including an acoustical model and a statistical model;

FIG. 7a shows examples of sound pressure level versus frequency for calibrated hearing aid sitting in a coupler;

FIG. 7b shows examples of sound pressure level versus frequency for calibrated hearing aid sitting in a randomly selected real ear canal;

FIG. 8 shows a range of curves including values generated by the acoustical model;

FIG. 9 shows a range of curves each including RECD values wherein a mean value is subtracted;

FIG. 10 shows sound pressure levels versus frequency for r_{obs}, rₖ and measured RECD in a first example;

FIG. 11 shows sound pressure level versus frequency for r_{obs}, rₖ and measured RECD in a second example; and

FIG. 12 shows a flowchart for a method using an acoustical model and a statistical model.

### DETAILED DESCRIPTION

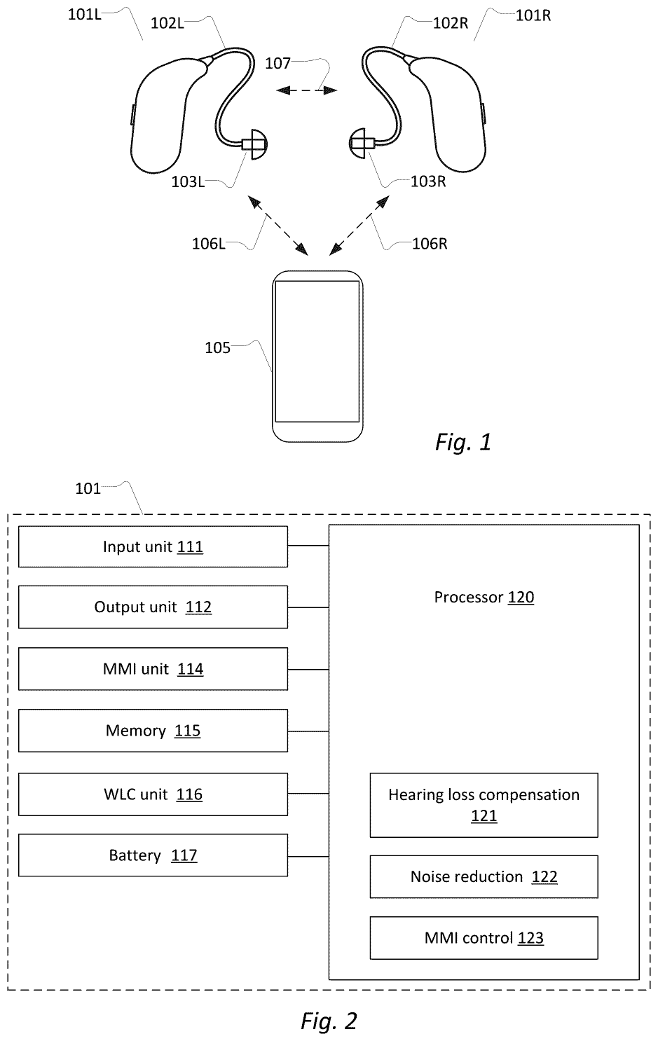

FIG. 1 shows an illustration of hearing aids and an electronic device. The electronic device 105 may be a smartphone or another electronic device capable of short-range wireless communication with the hearing aids 101L and 101R via wireless links 106L and 106R. The electronic device 105 may alternatively be a tablet computer, a laptop computer, a remote wireless microphone, a TV-box interfacing the hearing aids with a television or another electronic device.

The hearing aids 101L and 101R are configured to be worn behind the user's ears and comprises a behind-the-ear part and an in-the-ear part 103L and 103R. The behind-the-ear parts are connected to the in-the-ear parts via connecting members 102L and 102R. However, the hearing aids may be configured in other ways e.g., as completely-in-the-ear hearing aids. In some examples, the electronic device is in communication with only one hearing aid e.g., in situations wherein the user has a hearing loss requiring a hearing aid at only one ear rather than at both ears. In some examples, the hearing aids 101L and 101R are in communication via another short-range wireless link 107, e.g., an inductive wireless link.

The short-range wireless communication may be in accordance with Bluetooth communication e.g., Bluetooth low energy communication or another type of short-range wireless communication. Bluetooth is a family of wireless communication technologies typically used for short-range communication. The Bluetooth family encompasses ‘Classic Bluetooth’ as well as ‘Bluetooth Low Energy’ (sometimes referred to as “BLE”).

FIG. 2 shows a first block diagram of a hearing aid. The hearing aid 101 comprises an input unit 111, an output unit 112, a man-machine interface unit MMI, 114, a memory 115, a wireless communication unit (WLC unit) 116, a battery 117 and a processor 120. The battery may be a single-use battery or a rechargeable battery. The processor 120 may comprise a unit 121 configured to perform hearing loss compensation, a unit 122 configured to perform noise reduction, and a unit (MMI control) 123 for controlling man-machine interfacing.

The input unit 111 is configured to generate an input signal representing sound. The input unit may comprise an input transducer, e.g., one or more microphones, for converting an input sound to the input signal. The input unit 111 may include e.g., two or three external microphones configured to capture an ambient sound signal and an in-ear microphone capturing a sound signal in a space between the tympanic member (the eardrum) and a portion of the hearing aid. Additionally, the input unit may comprise a wireless receiver for receiving a wireless signal comprising or representing sound and for providing the signal representing sound.

The output unit 112 may comprise an output transducer. The output transducer may comprise a loudspeaker (sometimes denoted a receiver) for providing an acoustic signal to the user of the hearing aid. The output unit may, additionally or alternatively, comprise a transmitter for transmitting sound picked up by the hearing aid to another device.

One or both of the input unit 111 and the noise reduction unit 122 may be configured as a directional system. The directional system is adapted to spatially filter sounds from the surroundings of the user wearing the hearing aid, and thereby enhancing sounds from an acoustic target source (e.g., a speaking person) among a multitude of acoustic sources in the surroundings of the user. The directional system may be adapted to detect, e.g., adaptively detect, from which direction a particular part of the microphone signal originates. This can be achieved in different ways as described e.g., in the prior art. In hearing aids, a microphone array beamformer is often used for spatially attenuating background noise sources. The beamformer may comprise a linear constraint minimum variance (LCMV) beamformer. Many beamformer variants can be found in literature. The minimum variance distortionless response (MVDR) beamformer is widely used in microphone array signal processing. Ideally the MVDR beamformer keeps the signals from the target direction (also referred to as the look direction) unchanged, while attenuating sound signals from other directions maximally. The generalized sidelobe canceller (GSC) structure is an equivalent representation of the MVDR beamformer offering computational and numerical advantages over a direct implementation in its original form.

The man-machine interface unit 114 may comprise one or more hardware elements, e.g., one or more buttons, one or more accelerometers and one or more microphones, to detect user interaction.

The wireless communication unit 116 may include a short-range wireless radio e.g., including a controller in communication with the processor.

The processor may be configured with a signal processing path receiving audio data via the input unit with one or more microphones and/or via a radio unit; processing the audio data to compensate for a hearing loss; and rendering processed audio data via an output unit e.g., comprising a loudspeaker. The signal processing path may comprise one or more control paths and one or more feedback paths. The signal processing path may comprise a multitude of signal processing stages.

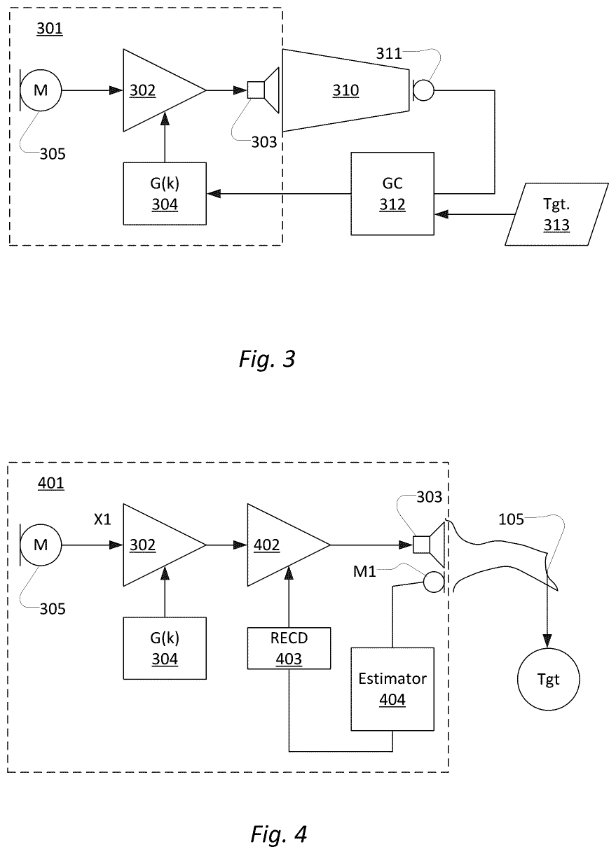

FIG. 3 shows a hearing aid arranged in a coupler. This is a conventional set-up for calibration of a hearing aid. The coupler 310 serves as a simulator of a standardized ear. The coupler has a duct with a proximal end, corresponding to the opening of the standardized ear canal, and a distal end, corresponding to the eardrum-end of the ear canal. The coupler 310 can provide a measurement of the sound pressure level at the coupler's distal end using a microphone 311. The coupler 310 is configured to receive a hearing aid 301 or an in-ear portion of the hearing aid at its proximal end and it is configured with a coupler microphone 311 at its distal end. It is thereby possible to obtain a measurement of a sound pressure level corresponding to the sound pressure level at an eardrum, albeit in a standardized ear. Couplers are well-known known and widely used in the hearing care industry to provide a standardized measurement and to obtain/verify a target sound pressure level. A target sound pressure level is e.g., 52 dB at all frequency channels.

Well-known couplers include a so-called 2 cc coupler having 2 cubic centimetres of coupler volume in the duct. It is known however, that the sound pressure level at the eardrum in a real ear may differ significantly from the standardized ear simulated by the coupler.

In a conventional use of the coupler, the hearing aid 301 is calibrated and/or verified to deliver a target sound pressure 313 at the distal end of the coupler. In some examples, a target sound pressure is 52 dB at each frequency channel. A gain calibrator GC, 312 compares the measured sound pressure levels from the microphone 311 and the target sound pressures and computes frequency specific gain values G(k), wherein k designates a frequency channel. The frequency specific gain values are stored in the memory 304 included in the hearing aid 301. The frequency specific gain values obtained during the calibration can then be applied to a gain stage 302 to enable a calibrated output e.g., when a reference sound pressure at e.g., 52 dB is captured by the microphone 305.

When used in a real ear, despite being calibrated using the coupler 310, the hearing aid 301 will most likely deliver a sound pressure level different from the target sound pressure level that the hearing aid was calibrated to in the coupler. A hearing care professional may therefore conduct a measurement of the sound pressure level at the eardrum using a measurement device with a probe tube inserted temporarily into and right next to the eardrum. Real-ear-to-coupler Difference, RECD, may thereby be obtained for a specific wearer's ear canal and included as a fitting parameter in the hearing aid. Typically, the hearing aid is then fitted to a user in accordance with a prescribed hearing loss compensation.

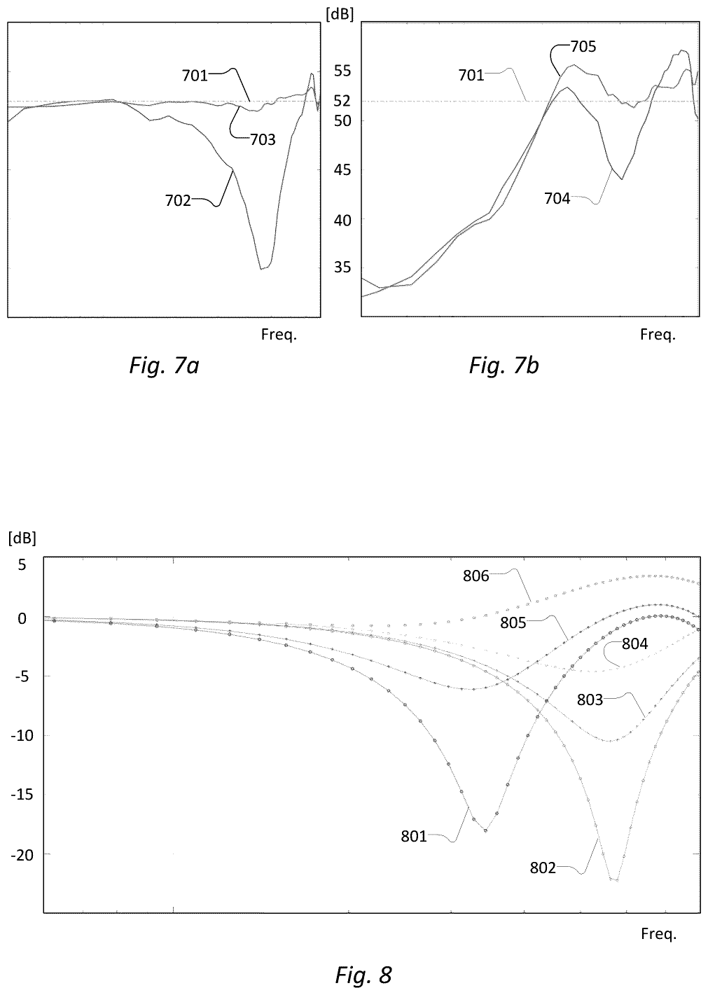

FIG. 7a shows examples of sound pressure level versus frequency for calibrated hearing aid sitting in a coupler. The curve 701 shows a target sound pressure e.g., at 52 dB. The curve 702 shows the sound pressure level captured by an inward facing microphone included in the hearing aid, and the curve 703 shows a sound pressure level measured using the coupler's microphone. As can be easily observed there is a significant difference between measurements at an eardrum level and measurements at a distance from the eardrum.

FIG. 4 shows a hearing aid arranged in a real ear. In contrast to the hearing aid shown in FIG. 3, the hearing aid 401 in FIG. 4 includes an inward facing microphone M1, which is arranged in the hearing aid, but at a distance from the eardrum, such that it receives sound signals from within the ear canal.

The hearing aid 401 includes an estimator 404, configured to receive a signal from the inward-facing microphone M1, and estimate a Real-ear-to-coupler Difference, RECD, 403 based on the measurement at a distance from the eardrum. This may be performed on a recurring basis while the hearing aid is in normal use in the wearer's ear canal, or it may be performed in response to a detected event. Examples of detected events may be that the hearing aid is inserted into an ear canal, that a user input is received via the hearing aid or via an electronic device such as a smartphone or smartwatch. The RECD difference includes a value for each frequency channel or each of predefined frequency bands.

It has been attempted in the prior art to device an estimator of RECD using a hearing aid with an inward facing microphone to dispense with the need for a measurement device with a probe tube, but there a need for an accurate and robust estimator using the inwards microphone remains.

FIG. 7b shows examples of sound pressure level versus frequency for calibrated hearing aid sitting in a randomly selected real ear canal. The curve 701 shows a target sound pressure e.g., at 52 dB. The curve 704 shows the sound pressure level captured by an inward facing microphone included in the hearing aid, and the curve 703 shows a sound pressure level measured using a measurement device with a probe tube inserted close to the eardrum. As can be easily observed there is a significant difference between measurements at an eardrum level and measurements at a distance from the eardrum. It can also be observed, when comparing to FIG. 7a, that a hearing aid calibrated using a coupler delivers a significantly different sound pressure level in a real ear.

### EXAMPLE

Herein, sound pressure levels may simply be denoted levels.

In one example, in accordance with a frequency-domain observation model, the known level measured at the ear-canal microphone is modelled as a sum of the unknown, but desired, level at the eardrum plus the gain of an unknown transfer function representing a relation between levels at the eardrum and levels at the ear-canal microphone plus a noise term.

This may be expressed as follows:

$${L}_{o b s} = {L}_{e d} + {h}_{e c} + v ,$$

Wherein L_{obs} is a vector of levels measured at the entrance to the ear canal, L_{ed} denotes the levels at the ear drum (to be estimated), h_{ec} is the ear canal transfer function magnitude, and ν is the vector of measurement noise levels.

For the sake of completeness, the vectors L_{obs}, L_{ed}, h_{ec}, ν are column vectors with K elements corresponding to K frequency channels.

As described above, the hearing aid may be calibrated to deliver a set target level L_{tgt} in a coupler. The target level L_{tgt} is e.g., set to 52 dB for all K frequencies. However, as described above, when the hearing aid, which is calibrated to deliver a set target level L_{tgt}, e.g., at 52 dB for all frequencies, in a coupler, the actual level at the eardrum may be significantly different from the set target level.

It is possible to subtract L_{tgt} from both sides of the above equation:

$${L}_{o b s} - {L}_{t g t} = {L}_{e d} - {L}_{t g t} + {h}_{e c} + v ,$$

Which can be written as:

$${r}_{o b s} = r + {h}_{e c} + v ,$$

Wherein r [symbol] L_{ed}−L_{tgt} and r_{obs} [symbol] L_{obs}−L_{tgt}. Then, since L_{tgt} is known, r_{obs} can be calculated from the measured levels L_{obs}. However, both r and h_{ec} remain unknown.

Albeit h_{ec} is unknown, it has been found that an acoustical model with M1 parameters can represent the K-dimensional vector h_{ec} and that a statistical model with M2 parameters can represent the k-dimensional vector r.

It has been found that good results can be achieved with a relatively low number of parameters M1 and M2 compared to the number of K frequency channels i.e., M1«K and that M2«K.

The acoustical model, on the one hand, may be represented by the below closed form expression:

$${h}_{k} = A log \{ {\vert {V}_{k}^{+} {e}^{- j {γ}_{k} l} + {V}_{k}^{-} {e}^{j {γ}_{k} l} \vert}^{2} \} ,$$

Wherein hₖ is the k'th element of the vector h_{ec} and wherein A and Vₖ⁺ and Vₖ⁻ and l are parameters of the acoustical model. The expression includes a first term and a second term each representing either a forward travelling wave or a reflected wave in an acoustic transmission line. At least in some examples Vₖ⁺=Vₖ⁻=0.5. γₖ is a function of the frequency channel index k, wherein (1≤k≤K).

$${γ}_{k}^{2} = ( R + j 2 π {f}_{k} L ) ( G + j 2 π {f}_{k} C )$$

Wherein R is set to 0 and L and C are set to the inverse of speed of air:

$$\begin{matrix}R = 0 \\ L = C = \frac{1}{{c}_{air}}\end{matrix} ,$$

Wherein cₐᵢᵣ is the speed of sound in air.

Thus, γₖ² is a function of frequency-independent parameters e.g., l, L, C, A and Vₖ⁺ and Vₖ⁻. Whereas L, C, R and Vₖ⁺ and Vₖ⁻ are fixed parameters, G is an independent parameter (e.g., the only independent parameter). All parameters are frequency independent, however γₖ² is a function of the frequency channel index, k. Thus, the closed form expression for hₖ needs estimation of only G and l which are frequency-independent parameters (i.e., having the same, one value for all frequency channels). A is a scaling constant.

The statistical model, on the other hand, may be based on database of measured RECD values for a cohort of ear canals. In particular, the vast amount of information in the database of measured RECD values may be represented by a decomposition into a set of basis vectors and a set of eigen values e.g., based on principal component analysis or independent component analysis or another method of obtaining dimensionality reduction.

Given RECD measurements of N randomly selected ear canals, the mean vector and covariance matrix of the RECD can be written as follows:

$$\begin{matrix}{μ}_{r} = \frac{1}{N} {\sum }_{i = 1}^{N} {r}_{i} \\ {C}_{r} = \frac{1}{N} {\sum }_{i = 1}^{N} ( {r}_{i} - {μ}_{r} ) {( {r}_{i} - {μ}_{r} )}^{T}\end{matrix}$$

where rᵢ is the RECD vector for the i^{th} ear canal

From the above discussion, it follows that given the eigenvalue decomposition of Cᵣ as:

Cᵣ=UΛU^{T},

it is very likely that r−μᵣ has a sparse representation using the following transformation:

$$s = {U}^{T} ( r - {μ}_{r} ) .$$

In almost all cases, number of the significant coefficients is limited to n=5. It follows that almost any unknown RECD r can be represented as:

$$r = {μ}_{r} + U s ,$$

where μᵣ and U are known (derived from an existing dataset) and the unknown vector s has no more than n nonzero coefficients, where n is much smaller than the dimension of r. Therefore r can be represented using only n parameters.

Based on the above, parameters (G, A, l) included in the acoustical model and the parameters (s₁, s₂, . . . , sₙ) included in the statistical model can be jointly estimated.

Values output by the acoustical model can be denoted hₖ wherein k=1, . . . , K. Omitting the frequency index, the output can be denoted by h(G, A, l), emphasizing the dependency on the unknown parameters G, A and l.

Denoting the n nonzero components of s by s₁, s₂, . . . , sₙ, the RECD vector can be denoted by r(s₁, s₂, . . . , sₙ). The problem of jointly estimating h(G, A, l) and r(s₁, s₂, . . . , sₙ) can be reformulated as estimating the parameters G, A, l, s₁, s₂, . . . , sₙ. In one example, this is formulated as a least-squares fitting of h(G, A, l) and r(s₁, s₂, . . . , sₙ) to the known observation r_{obs} based on the observation model above. In other words, G, A, l, s₁, s₂, . . . , sₙ are given by:

$${min}_{G , A , l , {s}_{1} , {s}_{2} , … , {s}_{n}} {‖ {r}_{o b s} - r ( {s}_{1} , {s}_{2} , … , {s}_{n} ) - h ( G , A , l ) ‖}^{2} .$$

In practice, some of the parameters are bounded. For example, G and A cannot be negative. Also, there are bounds on the ear canal length. To integrate these restrictions in the estimation problem, a set of constraints is added to obtain the final formulation as follows:

$${min}_{G , A , l , {s}_{1} , {s}_{2} , … , {s}_{n}} {‖ {r}_{o b s} - r ( {s}_{1} , {s}_{2} , … , {s}_{n} ) - h ( G , A , l ) ‖}^{2}$$

$$subject to \{ \begin{matrix}\begin{matrix}{s}_{i}^{( μ )} - {δ}_{i} \leq {s}_{i} \leq {s}_{i}^{( μ )} + {θ}_{i} , & for i = 1 , … , n\end{matrix} \\ G , A \geq 0 \\ {l}_{min} \leq l \leq {l}_{max}\end{matrix}$$

where δᵢ and θᵢ are positive constants, and sᵢ^{(μ)} are derived from the representation of μᵣ in the U domain, i.e., s^{(μ)}=U^{T}μᵣ. The first constraint guarantees that the estimated RECD does not deviate unreasonably from the mean μᵣ. The third constraint sets limits on the ear canal length. The resulting constrained nonlinear least-squares fitting problem can be solved e.g., numerically.

Values of optimized parameters {s₁, s₂, . . . , sₙ} may be denoted {s₁, s₂, . . . , sₙ}* and values of optimized parameters {G, A, l, s₁, s₂, . . . , sₙ} may be denoted {G, A, l, s₁, s₂, . . . , sₙ}*.

At least based on the above example, various embodiments can be devised.

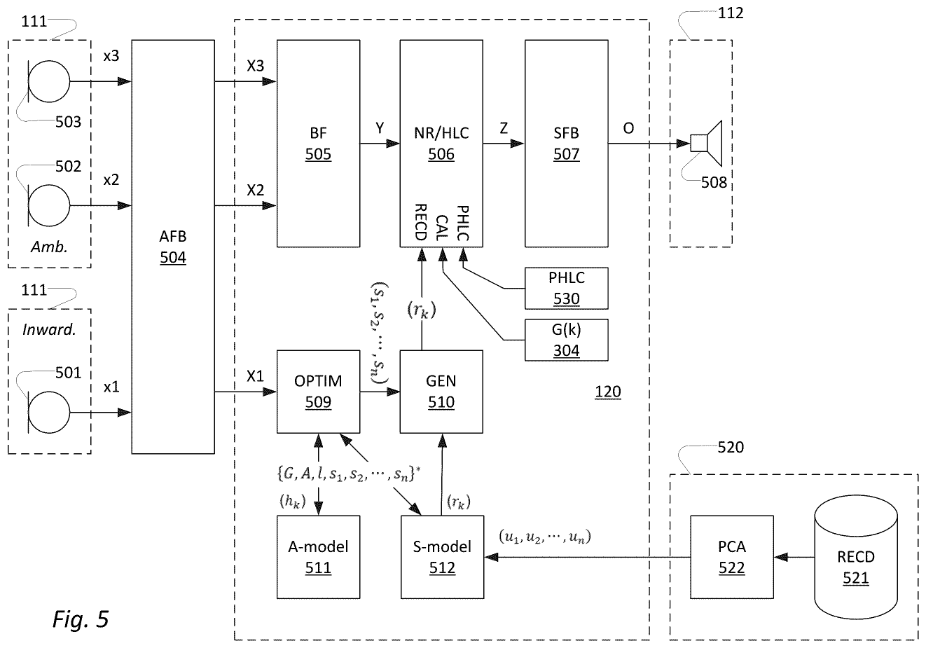

FIG. 5 shows a block diagram of a hearing aid including an acoustical model and a statistical model. The hearing aid processor 120 is coupled to receive signals from the input unit 111 and to output a signal to the output unit 112. The input unit 111 includes an inward facing, first microphone 501 and ambient microphones including a second microphone 502 and a third microphone 503. The inward facing, first microphone 501 is configured to output a signal x1; the second microphone outputs a signal x2 and the third microphone outputs a signal x3. The ambient microphones may be arranged as a so-called front microphone and as a so-called rear microphone in the hearing aid. The output unit 112 includes a loudspeaker 310.

It should be noted that for so-called completely-in-the-ear hearing aids, the hearing aid may include only one ambient microphone rather than two or more ambient microphones. The output unit 112 and the inward facing microphone 501 may be arranged closely together e.g., closely integrated in a common housing. For so-called behind-the-ear, BTE, hearing aids, the hearing aid includes an in-the-ear part accommodating the output unit 112 and the inward facing microphone 501, wherein the ambient microphones are arranged in the BTE part.

Other configurations are possible.

The processor 120 includes an analysis filter bank AFB, 504 decomposing the input signals x1, x2 and x3 into multiple frequency channels each with band-limited signals, e.g., so-called time-frequency signals X1, X2 and X3 in a time-frequency representation. The time-frequency signals may include a sequency of frames, wherein each frame includes time-frequency bins X(n,k), wherein n is a time index and k is a frequency channel index. In some embodiments the analysis filter bank AFB, 504 performs Fast Fourier Transformations, FFT. In some embodiments the analysis filter bank AFB, 504 is implemented by multiple band-pass filters. In some embodiments the analysis filter bank decomposes the input signals into the multiple frequency channels in such a way that the input signal can be reconstructed e.g., perfectly reconstructed, e.g., without colouring the reconstructed signal relative to the input signal. Reconstruction may include summing signals in the multiple frequency channels. Reconstruction may include filtering. A time-frequency bin may include one or more samples.

The processor 120 includes a beamformer 505, which receives the time-frequency signals X2 and X3 and outputs a time-frequency signal Y, which is a directional signal, whereas the signals X3 and X3 may be e.g., omnidirectional signals. In some embodiments the beamformer 505 is a Minimum Variance Distortion-less (MVDR) beamformer. Ideally the MVDR beamformer keeps the signals from the target direction (also referred to as the look direction) unchanged, while attenuating sound signals from other directions maximally. The generalized sidelobe canceller (GSC) structure is an equivalent representation of the MVDR beamformer offering computational and numerical advantages over a direct implementation in its original form.

The processor 120 includes a NR/HLC processor 506 configured to perform one or more of noise reduction, NR, and hearing loss compensation, HLC. The NR/HLC processor 506 outputs the signal Z in accordance with calibration values, CAL, prescribed hearing loss compensation values, PHLC, 530 and RECD values. In particular, the RECD values are obtained from a generator 510 providing values r(k), wherein k is an index to a frequency channel. The NR/HLC processor 506 may also include a feedback manager configured to reduce the risk feedback howling etc.

The processor 120 includes a synthesis filter bank 507 configured to convert the time-frequency domain signal Z into a time-domain signal, O, for the output transducer 508. The output transducer can thus emit a first output signal to produce an acoustical signal in an ear canal.

Herein, RECD values are also referred to as a vector, rₖ, including estimated values, wherein k is an index to frequency channels. To determine the estimated values in rₖ, the processor includes an acoustical model 511 and a statistical model 512. The acoustical model is configured to generate first values (hₖ) including values for each of the multiple frequency channels based on first parameters (G, A, l) e.g., as described in the example above or in another way. The statistical model is configured to generate second values (rₖ) including values for each of the multiple frequency channels based on second parameters (s₁, s₂, . . . , sₙ) and a set of basis vectors (u₁, u₂, . . . , uₙ) e.g., as described in the example above or in another way. The acoustical model including the basis vectors (u₁, u₂, . . . , uₙ) is obtained from an electronic device 520 e.g., via a download signal e.g., during production of the hearing aid, during a fitting session, and/or in connection with a firmware update. The electronic device 520 loads or accesses a database 521 of RECD values for a number of persons, e.g., more than 20 persons, and computes an eigenvalue decomposition including eigenvectors (basis vectors) e.g., based on a Principal Component Analysis, PCA, or another component analysis method 522. Since the computations involved in performing the eigenvalue decomposition may require a substantial amount of processing resources and memory, the eigenvalue decomposition is performed at the electronic device rather than at the hearing aid.

The processor 120 includes an optimizer 509 that is configured to determine an optimal set of parameter values ({G, A, l, s₁, s₂, . . . , sₙ}*) based on the acoustical model 511 and the statistical model 512. The optimizer iteratively computes a difference between sound pressure levels (r_{obs}), obtained via the inward facing microphone 501, and a sum of the values (hₖ) and the values (rₖ) obtained using the acoustical model and the statistical model, respectively. The difference is minimized e.g., in accordance with a steepest descent algorithm, by adjusting the values of the parameters at least until a stopping criterion is reached. An optimized set of parameter values is thereby obtained.

However, to compute the values rₖ, the statistical model is applied to process the sound pressure levels, r_{obs}, in accordance with the parameter values {s₁, s₂, . . . , sₙ}* from the optimized set of parameter values. In this respect, the acoustical model is dispensed with. The values rₖ is then stored for use by the NR/HLC processor 506 and the NR/HLC processor 506 processes signals from the ambient microphones in accordance with values rₖ. The values rₖ may be uploaded to an electronic device for remote storage e.g., for being displayed and/or analysed.

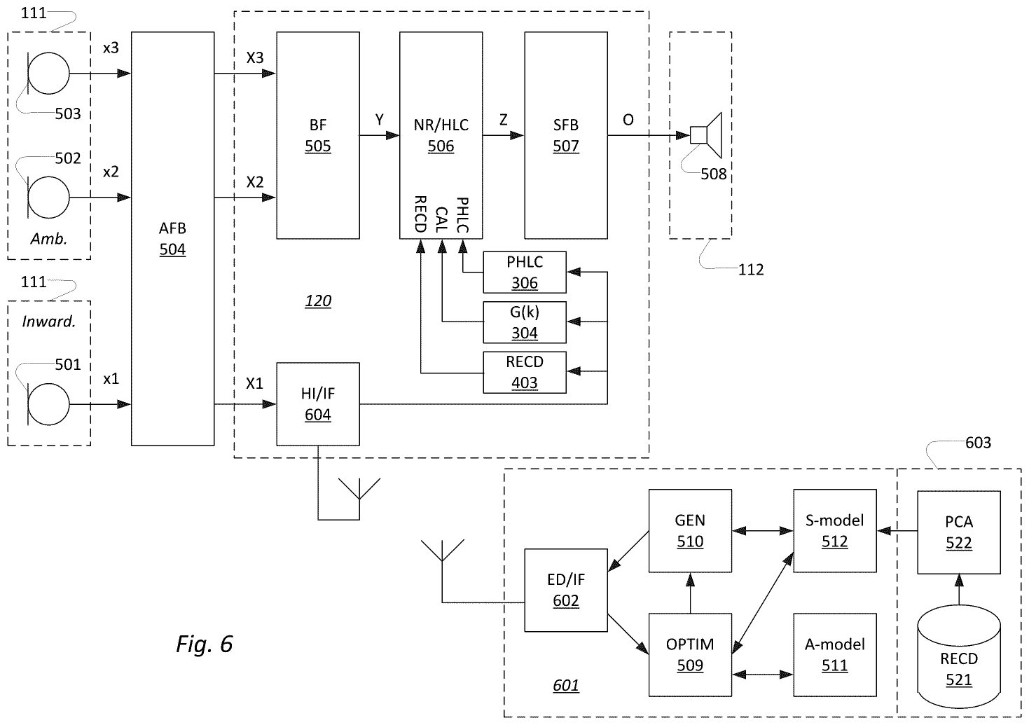

FIG. 6 shows a block diagram of a hearing aid and an electronic device including an acoustical model and a statistical model. In this embodiment, the hearing aid includes a communication interface 604 to communicate with an electronic device 601 that includes a communication interface 602. The communication interfaces may include a radio for wireless communication e.g., according to a Bluetooth specification e.g., a Bluetooth Low Energy, BLE, specification.

The communication interface 601 enables the processor 120 to transmit a signal X1, or a representation of the signal X1, from the inward facing microphone 501 to the electronic device 601 and to receive the estimated values r(k). Further, the communication interface may be configured to receive prescribed hearing loss compensation values and/or calibration values.

The electronic device includes the optimizer 509, a generator 510, the statistical model 512 and the acoustical model 511. Also, the electronic device 601 loads or accesses a database 521 of RECD values for a number of persons, e.g., more than 20 persons, and computes an eigenvalue decomposition including eigenvectors (basis vectors) e.g., based on a Principal Component Analysis, PCA, or another component analysis method 522. The basis vectors or at least a subset of the basis vectors are used by the statistical model. In some respects, the basis vectors or at least the subset of the basis vectors are not computed at the electronic device, but at a remote device 603.

The processor 120 and/or the electronic device 601 may communicate on a recurring basis while the hearing aid is in normal use in the wearer's ear canal, or in response to a detected event to generate updated estimated values r(k). Examples of detected events may be that the hearing aid is inserted into an ear canal, that a user input is received via the hearing aid or via an electronic device such as a smartphone or smartwatch.

Generally, the processor includes hardware elements performing processing operations in accordance with a program e.g., in the form of firmware. The firmware may include data e.g., including a representation of the acoustical model and the statistical model.

FIG. 8 shows a range of curves including values generated by the acoustical model. Each curve 801, 802, 803, 804, 805, and 806 in the range corresponds to an output of the acoustical model given specific values of the parameters e.g., G, A, l as set out in the example the acoustical model. As can be seen, the acoustical model is capable of modelling quite different, albeit realistic ear canals. In some examples the model generates a value for each frequency channel.

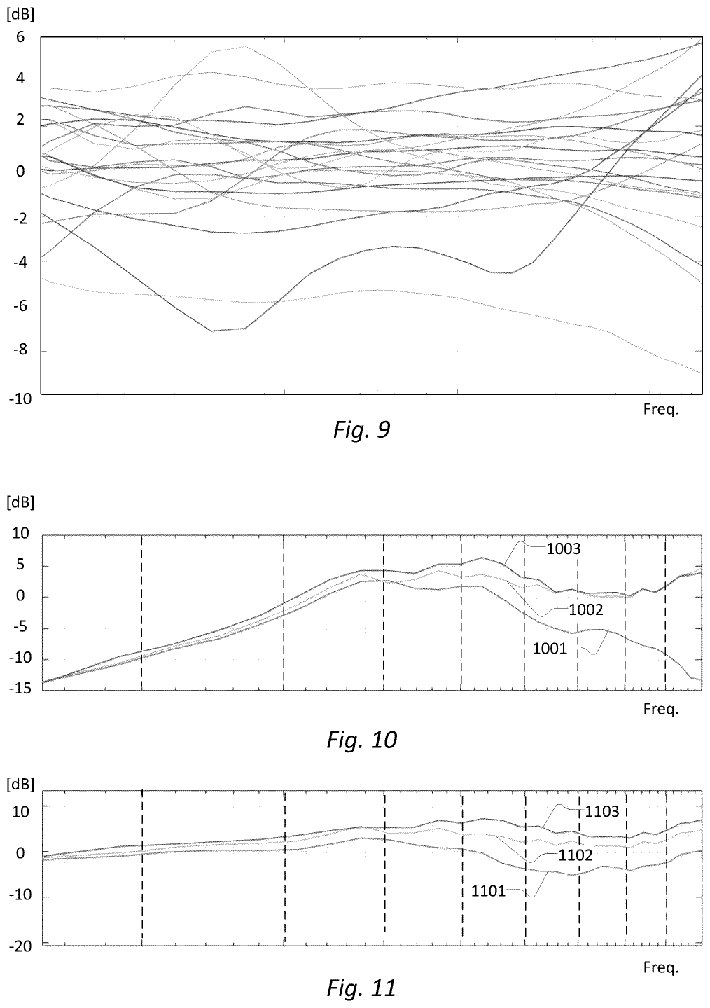

FIG. 9 shows a range of curves each including RECD values obtained by the statistical model, wherein a mean value is subtracted. The range of curves includes about 20 curves corresponding to frequency specific RECD values for 20 real ear canals. Based on these RECD values, obtained from about 20 ear canals, the statistical model can model a specific ear canal. Parameter values for the statistical model can be estimated jointly with parameter values of the acoustical model. The statistical model enables a compact representation of variation represented by the RECD values for 20 real ear canals. The statistical model can form a well-posed estimation problem for estimation of the parameter values, rather than an ill-posed estimation problem.

FIG. 10 shows sound pressure levels versus frequency for r_{obs}, rₖ and measured RECD in a first example. In this example, corresponding to a specific ear canal (different from each of the ear canals referred to in FIG. 9) the curve 1001 represents r_{obs} i.e., the sound pressure levels measured by an inward facing microphone. The curve 1002 represents rₖ i.e., estimated RECD values obtained by the statistical model and the curve 1003 represents RECD values measured by measurement device with a probe tube inserted close to the eardrum. The estimated values 1002 fit with the measured values 1003.

FIG. 11 shows sound pressure level versus frequency for r_{obs}, rₖ and measured RECD in a second example. In this example, corresponding to a specific ear canal (different from each of the ear canals referred to in FIG. 9) the curve 1101 represents r_{obs} i.e., the sound pressure levels measured by an inward facing microphone. The curve 1102 represents rₖ i.e., estimated RECD values obtained by the statistical model and the curve 1103 represents RECD values measured by measurement device with a probe tube inserted close to the eardrum. The estimated values 1102 fit with the measured values 1003.

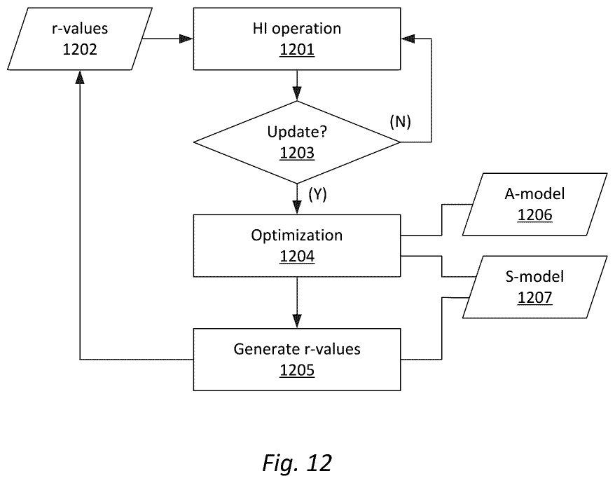

FIG. 12 shows a flowchart for a method using an acoustical model and a statistical model. According to the flowchart, the hearing aid performs normal hearing aid operation in step 1201. The normal hearing aid operation includes performing hearing loss compensation and performing gain correction in accordance with frequency specific RECD values, here the RECD values are designated r-values. In step 1203 the hearing aid recurringly determines to update the r-values (Y) or to forgo updating (N) the r-values e.g., based on detecting an event as described herein.

In accordance with a determination to update the r-values, optimization of values for the acoustical model 1206 and for the statistical model 1207 is performed in step 1204. The optimization is based on a signal or values from the inward facing microphone at the hearing aid.

Subsequently, in step 1205, updated r-values 1202 are generated using the statistical model 1207 based on optimized values for the statistical model 1207.

The updated r-values 1202 are subsequently included in the normal hearing aid operation including performing gain correction in accordance with frequency specific RECD values, designated r-values.

In some examples, the optimization 1204 using the acoustical model 1206 and using the statistical model 1207 and the generation of the r-values are performed at the hearing aid.

In some examples, the optimization 1204 using the acoustical model 1206 and using the statistical model 1207 and the generation of the r-values are performed at an electronic device associated with the hearing aid. The electronic device may be a smartphone, smartwatch or another electronic device configured for wireless communication with the hearing aid e.g., by pairing in accordance with a Bluetooth specification.

### ADDITIONAL ASPECTS

Herein, a ‘level’ generally refers to an absolute value e.g., a power level. A ‘level’ may be obtained by e.g., a 1^{st} order IIR filter or by a sample-and-hold filter e.g., applying different ‘attack’ and ‘release’ time constants.

Herein, the one or more processors, e.g., including the processor 120, may include one or more integrated circuits embodied on one or more integrated circuit dies. The one or more processors including filters, the multiplexer and other units may be implemented by software performed by the one or more integrated circuits. The filters, the multiplexer and other units may thus be virtual units rather than distinct physical units.

The one or more processors may include one or more of: one or more analysis filter banks, one or more synthesis filter banks, one or more beamformers, one or more units configured to generate a compensation for a hearing loss, e.g., a prescribed hearing loss, one or more controller units, and one or more post-filters. The analysis filter banks may convert a time-domain signal to a time-frequency domain signal. The synthesis filter banks may convert a time-frequency domain signal to a time-domain signal. The post-filter may provide time-domain filtering and/or time-frequency domain filtering. The controller may be configured to control portions or units of the one or more processors and/or a transmitter/receiver/transceiver e.g., based on one or more programs, e.g., in response to signals from one or more hardware elements configured for receiving user inputs. The compensation for a hearing loss may be quantified during a fitting session, e.g., a remote fitting session. The one or more processors may be configured to execute instructions stored in the memory and/or stored in the processor.

The output unit may comprise one or more of: one or more amplifiers, one or more loudspeakers, e.g., miniature loudspeakers, one or more wireless transmitters, e.g., including transceivers.

In an embodiment, the hearing aid comprises a (single channel) post filter for providing further noise reduction (in addition to the spatial filtering of the beamformer filtering unit), such further noise reduction being e.g., dependent on estimates of SNR of different beam patterns on a time frequency unit scale, e.g., as disclosed in EP2701145-A1.

In the present context, a hearing aid, e.g., a hearing instrument, refers to a device, which is adapted to improve, augment and/or protect the hearing capability of a user by receiving acoustic signals from the user's surroundings, generating corresponding audio signals, possibly modifying the audio signals, and providing the possibly modified audio signals as audible signals to at least one of the user's ears. Such audible signals may e.g., be provided in the form of acoustic signals radiated into the user's outer ears, acoustic signals transferred as mechanical vibrations to the user's inner ears through the bone structure of the user's head and/or through parts of the middle ear as well as electric signals transferred directly or indirectly to the cochlear nerve of the user.

The hearing aid may be configured to be worn in any known way, e.g. as a unit arranged behind the ear with a tube leading radiated acoustic signals into the ear canal or with an output transducer, e.g. a loudspeaker, arranged close to or in the ear canal, as a unit entirely or partly arranged in the pinna and/or in the ear canal, as a unit, e.g. a vibrator, attached to a fixture implanted into the skull bone, as an attachable, or entirely or partly implanted, unit, etc. The hearing aid may comprise a single unit or several units communicating (e.g., acoustically, electrically or optically) with each other. The loudspeaker may be arranged in a housing together with other components of the hearing aid or may be an external unit in itself (possibly in combination with a flexible guiding element, e.g., a dome-like element).

A hearing aid may be adapted to a particular user's needs, e.g., a hearing impairment. A configurable signal processing circuit of the hearing aid may be adapted to apply a frequency and level dependent compressive amplification of an input signal. A customized frequency and level dependent gain (amplification or compression) may be determined in a fitting process by a fitting system based on a user's hearing data, e.g., an audiogram, using a fitting rationale (e.g.

adapted to speech). The frequency and level dependent gain may e.g., be embodied in processing parameters, e.g., uploaded to the hearing aid via an interface to a programming device (fitting system), and used by a processing algorithm executed by the configurable signal processing circuit of the hearing aid.

A ‘hearing system’ refers to a system comprising one or two hearing aids, and a ‘binaural hearing system’ refers to a system comprising two hearing aids and being adapted to cooperatively provide audible signals to both of the user's ears. Hearing systems or binaural hearing systems may further comprise one or more ‘auxiliary devices’, which communicate with the hearing aid(s) and affect and/or benefit from the function of the hearing aid(s). Such auxiliary devices may include at least one of a remote control, a remote microphone, an audio gateway device, an entertainment device, e.g., a music player, a wireless communication device, e.g., a mobile phone (such as a smartphone) or a tablet or another device, e.g. comprising a graphical interface. Hearing aids, hearing systems or binaural hearing systems may e.g., be used for compensating for a hearing-impaired person's loss of hearing capability, augmenting, or protecting a normal-hearing person's hearing capability and/or conveying electronic audio signals to a person. Hearing aids or hearing systems may e.g., form part of or interact with public-address systems, active ear protection systems, handsfree telephone systems, car audio systems, entertainment (e.g., TV, music playing or karaoke) systems, teleconferencing systems, classroom amplification systems, etc.

Other methods and hearing aids are defined by the below items. Aspects and embodiments of the other methods and hearing aids defined by the below items include the aspects and embodiments presented in the summary section.

1. A hearing aid including a processor; comprising:
a first microphone arranged to capture sounds in an ear canal and generate a first signal;
a level estimator determining first sound pressure levels (r_{obs}) at multiple frequency channels;
an acoustical model configured to generate first values (hₖ) for the multiple frequency channels based on first parameters (G, A, l);
a statistical model configured to generate second values (rₖ) for the multiple frequency channels based on values of second parameters (s₁, s₂, . . . , sₙ) and a set of vectors (u₁, u₂, . . . , uₙ) including values.

2. A hearing aid including a processor, a first microphone, a second microphone; wherein the first microphone is arranged to capture ear-canal sounds, and wherein the second microphone is arranged to capture ambient sounds; comprising:
an acoustical model configured to generate first values (hₖ) for the multiple frequency channels based on first parameters (G, A, l);
a statistical model configured to generate second values (rₖ) for the multiple frequency channels based on values of second parameters (s₁, s₂, . . . , sₙ) and a set of basis vectors (u₁, u₂, . . . , uₙ);
an optimizer configured to obtain an optimized set of parameter values ({G, A, l, s₁, s₂, . . . , sₙ}*) by joint estimation including values of the first parameters and values of the second parameters; and
a generator configured to obtain the second values using the statistical model in combination with the second parameters included in the optimized set of parameter values.

3. A hearing aid including a processor; comprising:
a first microphone arranged to capture sounds in an ear canal and generate a first signal;
a level estimator determining first sound pressure levels (r_{obs}) at multiple frequency channels;
an acoustical model configured to generate first values (hₖ) for the multiple frequency channels based on first parameters (G, A, l);
a statistical model configured to generate second values (rₖ) for the multiple frequency channels based on values of second parameters (s₁, s₂, . . . , sₙ) and a set of vectors (u₁, u₂, . . . , uₙ) including values;
an optimizer configured to obtain an optimized set of parameter values ({G, A, l, s₁, s₂, . . . , sₙ}*) including values of the first parameters and values of the second parameters; wherein the optimized set of parameter values is obtained by minimizing a difference between the first sound pressure levels (r_{obs}) and a combination of the first values (rₖ) and the second values (hₖ); and
a generator configured to generate the second values (r*ₖ) for the multiple frequency channels based on the statistical model and at least the second parameter values ({s₁, s₂, . . . , sₙ}*) included in the optimized set of parameter values.

4. A hearing aid according to any of the above items, comprising a filter bank configured to divide the first signal into the multiple frequency channels and/or the divide the second signal into the multiple frequency channels.

5. A hearing aid according to any of the above items, wherein the first parameters include values that are frequency-channel-independent; and/or wherein the second parameters include values that are frequency-channel-independent.

6. A hearing aid according to any of the preceding items, wherein the second parameter values ({s₁, s₂, . . . , sₙ}*) included in the optimized set of parameter values and the vectors together model a specific set of real-ear-to-coupler differences, wherein the real-ear-to-coupler difference set includes a value for each frequency channel.

7. A hearing aid according to any of the preceding items, wherein the acoustical model and the statistical model generate linearly independent first values (hₖ) and second values (rₖ).

8. A hearing aid according to any of the preceding items, wherein, the acoustical model, and the statistical model mutually and/or in combination form a substantially orthogonal set of functions; wherein functions associated with the statistical model span at least two, three or four standard deviations of real-ear-to-coupler-difference data associated with at least 20 normal real ear canals.

9. A hearing aid according to any of the preceding items; wherein the vectors include basis vectors; and wherein each basis vector includes a value for each of the multiple frequency channels; and wherein the set of basis vectors (U) includes a vector (u₁, u₂, . . . , uₙ) for each of second parameters (s₁, s₂, . . . , sₙ).

10. A hearing aid according to any of the preceding items, wherein the vectors are obtained based on an eigenvalue decomposition, including eigenvectors (U), of the covariance matrix (Cᵣ) associated with a multitude of real-ear-to-coupler-differences; wherein the second values (r) are a function of the second parameter values (s₁, s₂, . . . , sₙ).

11. A hearing aid according to any of the preceding items, wherein the acoustical model includes an expression associated a gain transfer function from one end of a duct to another end of the duct; and wherein the statistical model is configured to enable representation of a real-ear-to-coupler difference based on the basis vectors.

12. A hearing aid according to any of the preceding items, wherein the acoustical model includes an expression including a term associated with a forward propagating sinusoidal wave and a term associated with a backward propagating sinusoidal wave.

13. A hearing aid according to any of the preceding items,

wherein the hearing aid includes a second microphone arranged to capture sounds from surroundings of a wearer of the hearing aid;

wherein the processor is configured to:
generate an output signal for the output transducer based on processing a signal from the second microphone; wherein the processing includes compensation for a prescribed hearing loss; and
include the second values (r*ₖ) to compensate a signal from the second microphone.

14. A hearing aid system according to any of the preceding items including an electronic device different from a hearing aid, wherein the electronic device is configured to:
obtain a multitude of real-ear-to-coupler-differences ([r₁, r₂, . . . , r_{I}]^{T};
compute a mean value vector (μᵣ) for the or the multitude of real-ear-to-coupler-differences;
compute a covariance matrix (Cᵣ) for the multitude of real-ear-to-coupler-differences; and
compute an eigenvector decomposition (U) of the covariance matrix (Cᵣ);

wherein the eigenvector decomposition (U) includes the basis vectors.

15. A hearing aid system according to any of the preceding items, wherein the hearing aid includes an antenna for wireless communication with an electronic device; wherein the electronic device includes a processor, a memory, and an antenna and is configured to:
store a representation of one or both of the acoustical model and the statistical model in the memory included in the electronic device;
determinine the optimized set of parameter values ({G, A, l, s₁, s₂, . . . , sₙ}*);
generate the second values (rₖ); and
transmit the second values (rₖ) to the hearing aid.

r*ₖ{s₁, s₂, . . . , sₙ}*

1. A method performed using a hearing aid including a processor, a first microphone, and an output transducer; wherein the first microphone is arranged to capture sounds inside a wearer's ear-canal at a distance from the eardrum; comprising:
emitting a first output signal using the output transducer;
receiving a first input signal using the first microphone, and determining first sound pressure levels (r_{obs}) at multiple frequency channels;
wherein an acoustical model is configured to generate first values (hₖ) including values for each of the multiple frequency channels based on first parameters (G,A, l);
wherein a statistical model is configured to generate second values (rₖ) including values for each of the multiple frequency channels based on second parameters (s₁, s₂, . . . , sₙ) and a set of basis vectors (u₁, u₂, . . . , u_{K});
determining a set of optimized parameter values ({G, A, l, s₁, s₂, . . . , sₙ}*) including values of the first parameters and values of the second parameters; wherein a difference between the first sound pressure levels (r_{obs}) and a combination of the first values (hₖ) and the second values (rₖ) is minimized via the acoustical model and the statistical model; and
generating the second values (r*ₖ) for the multiple frequency channels using the statistical model and at least the second parameter values ({s₁, s₂, . . . , sₙ}*) included in the optimized set of parameter values.

2. A method according to claim 1, wherein the first parameters include values that are frequency-channel-independent or wherein the second parameters include values that are frequency-channel-independent.

3. A method according to claim 1, wherein the first parameters include values that are frequency-channel-independent and wherein the second parameters include values that are frequency-channel-independent.

4. A hearing aid according to claim 1, wherein the second parameter values ({s₁, s₂, . . . , sₙ}*) included in the optimized set of parameter values and the vectors together model a specific set of real-ear-to-coupler differences, wherein the real-ear-to-coupler difference set includes a value for each frequency channel.

5. A method aid according to claim 1, wherein the acoustical model and the statistical model generate linearly independent first values (hₖ) and second values (rₖ).

6. A method according to claim 1, wherein, the acoustical model, and the statistical model mutually or in combination form a substantially orthogonal set of functions; wherein functions associated with the statistical model span at least two, three or four standard deviations of real-ear-to-coupler-difference data associated with at least 20 normal real ear canals.

7. A method according to claim 1, wherein the vectors include basis vectors;
and wherein each basis vector includes a value for each of the multiple frequency channels; and wherein the set of basis vectors (U) includes a vector (u₁, u₂, . . . , uₙ) for each of second parameters (s₁, s₂, . . . , sₙ).

8. A method according to claim 1, wherein the vectors are obtained based on an eigenvalue decomposition, including eigenvectors (U), of the covariance matrix (Cᵣ) associated with a multitude of real-ear-to-coupler-differences;
wherein the second values (r) are a function of the second parameter values (s₁, s₂, . . . , sₙ).

9. A method according to claim 1, wherein the acoustical model includes an expression associated a gain transfer function from one end of a duct to another end of the duct; and wherein the statistical model is configured to enable representation of a real-ear-to-coupler difference based on the basis vectors.

10. A method according to claim 1, wherein the acoustical model includes an expression including a term associated with a forward propagating sinusoidal wave and a term associated with a backward propagating sinusoidal wave.

11. A method according to claim 1, wherein the hearing aid includes a second microphone arranged to capture sounds from surroundings of a wearer of the hearing aid, comprising;
based on processing a signal from the second microphone, generating an output signal for the output transducer; wherein the processing includes compensation for a prescribed hearing loss;
wherein the processing includes the second values (r*ₖ) to compensate a signal from the second microphone.

12. A method according to claim 1, performed using a system including the hearing aid and an electronic device different from a hearing aid, comprising at the electronic device:
obtaining a multitude of real-ear-to-coupler-differences ([r₁, r₂, . . . , r_{I}]^{T});
computing a mean value vector (μᵣ) for the or the multitude of real-ear-to-coupler-differences;
computing a covariance matrix (Cᵣ) for the multitude of real-ear-to-coupler-differences;
computing an eigenvector decomposition (U) of the covariance matrix (Cᵣ);
wherein the eigenvector decomposition (U) includes the basis vectors.

13. A method according to claim 1, comprising:
at an electronic device, transmitting the basis vectors and the mean value vector (μᵣ) to the hearing aid.

14. A method according to claim 1, wherein the method is performed by a system including an electronic device with a display and a first radio; and wherein the hearing aid includes a second radio; comprising;
displaying a representation of the second values (r*ₖ) obtained for the multiple frequency channels using the second model and at least the second parameter values ({s₁, s₂, . . . , sₙ}*) included in the optimized set of parameter values;
wherein the electronic device and the hearing aid communicates, via the first radio and via the second radio, at least the first sound pressure levels (r_{obs}).

15. A method according to claim 1, wherein the hearing aid includes a second microphone arranged to capture sounds from surroundings of a wearer of the hearing aid; comprising:
receiving a second input signal using the second microphone, and determining second sound pressure levels at multiple frequency channels;
generating the output signal based on at least a signal from the second microphone; and
determining frequency channels at which one or both of the first sound pressure levels and the second sound pressure levels satisfy a first criterion, and enabling determining a set of optimized parameter values ({G, A, l, s₁, s₂, . . . , sₙ}*) only in accordance with a determination that the first criterion is satisfied for one or more, e.g., all, frequency channels.

16. A method according to claim 1, wherein the hearing aid includes an antenna for wireless communication with an electronic device; and wherein the method is performed at least in part by the electronic device including a display, a processor and an antenna; comprising:
storing a representation of one or both of the acoustical model and the statistical model in the memory included in the electronic device;
performing determining the optimized set of parameter values ({G, A, l, s₁, s₂, . . . , sₙ}*) at the electronic device;
generating the second values (rₖ) at the electronic device; and
transmitting the second values (rₖ) to the hearing aid.

17. A hearing aid including a processor, the hearing aid comprising:
a first microphone arranged to capture sounds in an ear canal and generate a first signal;
a level estimator determining first sound pressure levels (r_{obs}) at multiple frequency channels;
an acoustical model configured to generate first values (hₖ) for the multiple frequency channels based on first parameters (G, A, l);
a statistical model configured to generate second values (rₖ) for the multiple frequency channels based on values of second parameters (s₁, s₂, . . . , sₙ) and a set of vectors (u₁, u₂, . . . , uₙ) including values;
an optimizer configured to obtain an optimized set of parameter values ({G, A, l, s₁, s₂, . . . , sₙ}*) including values of the first parameters and values of the second parameters; wherein the optimized set of parameter values is obtained by minimizing a difference between the first sound pressure levels (r_{obs}) and a combination of the first values (rₖ) and the second values (hₖ); and
a generator configured to generate the second values (r*ₖ) for the multiple frequency channels based on the statistical model and at least the second parameter values ({s₁, s₂, . . . , sₙ}*) included in the optimized set of parameter values.
